(19) United States
(12) Patent Application Publication
(10) Pub. No.: US 2025/0131265 A1
(43) Pub. Date: Apr. 24, 2025

(54) METHOD FOR TRAINING AN ARTIFICIAL NEURAL NETWORK MODEL TO PREDICT THE BERTHING CAPACITY OF SHIPS, METHOD FOR PREDICTING THE BERTHING CAPACITY OF SHIPS AND NON-TRANSITORY COMPUTER-READABLE MEDIUM

(71) Applicant: PETROBRAS TRANSPORTE SA - TRANSPETRO, Rio de Janeiro (BR)

(72) Inventors: Andre Giovani LEAL FURLAN, Rio Grande (BR); Rafael Martins BARRAGAN LOY, São Francisco do Sul (BR)

(73) Assignee: PETROBRAS TRANSPORTE SA - TRANSPETRO, Rio de Janeiro, RJ (BR)

(21) Appl. No.: 18/919,180

(22) Filed: Oct. 17, 2024

(30) Foreign Application Priority Data
Oct. 24, 2023 (BR) 1020230221807

(51) Int. Cl. G06N 3/08; G01W 1/00

(52) U.S. Cl. CPC G06N 3/08; G01W 1/00

(57) ABSTRACT

The present invention relates to methods using artificial intelligence, AI, techniques to predict the berthing capacity of ships in onshore and offshore structures and comprises embodiments of a method for training an artificial neural network, ANN, model to predict the berthing capacity of ships, a method for predicting the berthing capacity of ships, and a non-transitory computer-readable medium.

### FIELD OF THE INVENTION

The present invention relates to the technical fields of maritime vessel traffic control technologies. More specifically, the present invention relates to methods using artificial intelligence, AI, techniques to predict the berthing capacity of ships at onshore and offshore structures.

### BACKGROUNDS OF THE INVENTION

Onshore and offshore structures, such as monobuoys, piers and platform relief vessels are used to load and unload oil from tankers.

These structures serve as a reception site for crude oil from ships. Subsequently, the crude oil is transmitted through subsea oil pipelines to a terminal for storage and subsequently transferred to a refinery through other onshore oil pipelines.

Accordingly, these structures are critical components of the oil industry and are susceptible to various environmental factors, especially weather conditions. Weather can pose significant risks to the safety and efficiency of the operations of these structures. Therefore, access to meteorological forecasts is essential for operators to make decisions about their operations.

However, since the interpretation of meteorological variables leaves room for subjectivity, there is a lack of objective criteria that can support the decision to berth ships in these structures and also support managers in evaluating decisions made by maneuver captains.

In this scenario, Artificial Intelligence (AI) has become a valuable resource for optimizing operations for loading and unloading oil from tankers, reducing the risk of incidents and improving the overall productivity and performance of these operations.

### STATE OF THE ART

The state of the art includes the disclosure of some documents that teach about the use of artificial intelligence techniques to assist in decision-making regarding activities related to maritime vessels.

The paper Applications of artificial intelligence in ship berthing: A review—2021 addresses to a literature review regarding applications of artificial intelligence in ship berthing. However, the paper is more specifically focused on a better understanding of the use of neural networks and algorithms to avoid collisions.

In this sense, the paper teaches that, in ship berthing, the use of artificial neural networks, ANN, begins with the training of ship data that includes sensors as input and responses from the ship, for example, desired thruster, rudder angle and engine output, and then applies the ANN as a ship controller for ship berthing control.

The paper Improved Methodology of Weather Window Prediction for Offshore Operations Based on Probabilities of Operation Failure—2016 is primarily applied to the wind energy industry sector and presents an updated methodology for meteorological window prediction that uses physical responses from vessels and offshore equipment to establish the expected probabilities of failure in operation, which, in turn, can be compared to the maximum allowed probability of failure to obtain adequate meteorological windows for operation.

However, the methodology proposed in the paper requires the step of developing a simulation model of physical equipment for offshore operations using hydrodynamic simulation software of choice, such as Abaqus/Aqua, SIMO, etc.

The paper Machine Learning Based Moored Ship Movement Prediction—2021 discloses the use of port data, aiming at creating neural networks and gradient boosting models that predict six degrees of freedom of a berthed vessel from ocean meteorological data and ship features.

Notably, in the aforementioned paper, the ship is already berthed. Accordingly, the discussed models are aimed at reliably comparing model predictions with movement limitation criteria for safe working conditions in ship loading/unloading operations, helping t the best location for operation and when to stop operations more accurately, minimizing the economic impact of cargo ships unable to operate.

The paper Assessing Operability on Berthed Ships. Common Approaches, Present and Future Lines—2020 aims at assessing the main current approaches to addressing to the operability of berthed vessels and explore current and future strategies. The document teaches that the objective of berthing and mooring operations is to allow cargo movement under conditions of functional safety and operational reliability. Wave action, together with other meteo-oceanographic forcing agents, such as wind, can cause excessive movement of berthed ships and, consequently, economic losses due to decreased operational performance.

To this end, the paper proposes strategies that include global simulation of mooring in reduced-scale modeling or numerical modeling, non-intrusive monitoring approaches, and the application of artificial monitoring techniques to study the dynamic actions of mooring and berthing lines.

As disclosed above, the documents identified in the state of the art primarily use artificial intelligence techniques to control ships and/or monitor ships that are already berthed. However, they apparently do not concern with obtaining an agile and direct indication of whether a ship should berth or not, with the help of artificial intelligence techniques.

Accordingly, there are still obvious deficiencies in the state of the art. In view of these deficiencies, the features and advantages of the present invention will clearly emerge from the following detailed description and with reference to the attached drawings, which are provided only as preferred and non-limiting embodiments.

### BRIEF DESCRIPTION OF THE INVENTION

The present invention relates to methods using artificial intelligence, AI, techniques to predict the berthing capacity of ships in onshore and offshore structures and comprises embodiments of a method for training an artificial neural network, ANN, model to predict the berthing capacity of ships, a method for predicting the berthing capacity of ships and a non-transitory computer-readable medium.

### BRIEF DESCRIPTION OF THE FIGURES

In order to complement the present description and obtain a better understanding of the features of the present invention, the following figures are presented.

FIG. 1 illustrates a general flowchart of the data and model.

FIG. 2 illustrates an exemplary structure of a neuron.

FIG. 3 illustrates an exemplary structure of a multilayer neural network, MLP.

FIG. 4 illustrates a topology of the adopted neural network.

FIG. 5 illustrates a general flowchart of the model structure.

FIG. 6 illustrates an example of a berthing probability graph, as a representation of the output of the neural network model.

### DETAILED DESCRIPTION OF THE INVENTION

The present invention relates to methods for training and applying artificial intelligence, AI, techniques to predict the berthing capacity of vessels in onshore and offshore structures.

The invention integrates historical data on meteorological forecast with operational data and then uses a combination of machine learning algorithms and statistical models to provide reliable predictions about the berthing capacity of vessels in any operation, and especially during severe weather conditions.

Several variables that can influence a vessel's berthing capacity safely and efficiently are considered and integrated into a neural network model to predict the probability of a ship being able to berth, which can help operators make informed decisions about scheduling and managing ship arrivals and departures at the terminal. This, in turn, can improve the efficiency and safety of operations at a terminal.

Additionally, the use of AI in conjunction with meteorological forecasts can bring several advantages to berthing operations, including:
Providing operators with real-time information about severe weather conditions that may pose a safety risk to operations. This information can be used to prepare for adverse weather conditions, such as adjusting loading/unloading procedures or even suspending operations until the weather improves;
Optimizing the timing of oil monobuoy operations, especially in situations where weather conditions may affect the efficiency of the loading or unloading process. For example, AI algorithms can use meteorological forecasts to predict the optimal time to load or unload oil, based on factors such as wind speed and wave height. This can help minimize the risk of spills and optimize operational efficiency.
Helping operators schedule maintenance activities. For example, AI algorithms can analyze meteorological forecasts to identify windows of opportunity for maintenance tasks, such as painting or repairing structures, without worrying about the effects of high winds or waves.

Accordingly, the use of AI and meteorological forecasts in oil berthing operations has several benefits. By optimizing the timing of loading and unloading operations, operators can minimize the risk of spills, which can have serious environmental and financial consequences. In addition, the use of AI and meteorological forecasts can help operators avoid the risks associated with adverse weather conditions, such as high winds, waves, and storms. In addition, the use of AI can increase the efficiency of oil monobuoy operations, thereby reducing operational costs and improving overall profitability.

Below, different aspects that make up the present invention will be discussed in detail.

### Data Structure

Historical data of at least one year of meteorological forecasts must be obtained. For example, these meteorological data can be obtained from the OCEANOP System (Sistema de Informações de Meteo-oceanografia Operacional) (Operational Meteo-Oceanography Information System) developed by PETROBRAS, which is a reliable and accurate source of information on oceanographic and meteorological conditions along the Brazilian coast. The OCEANOP program aims at supporting safe and efficient offshore operations by providing various products and services, such as oceanographic and meteorological forecasts, current and sea state maps, and advice on ship routes. The program collects various types of data, including wind speed and direction, wave height and period, from a network of meteorological and oceanographic sensors along the Brazilian coast.

The data collected is of high quality and detail, which is essential in the development and implementation of artificial intelligence tools. The data used consist of measurements of wind direction (degrees), sea current direction (degrees), significant wave height (meters), maximum sea wave height (meters), peak of sea wave period (seconds), wind speed (knots), wind gusts (knots), temperature (degrees °C.) and precipitation (3-hour total in mm), extracted at three-hour intervals, providing a comprehensive data set for analysis and modeling.

Nevertheless, it will be appreciated that the present invention could take advantage of or aggregate meteorological and oceanographic data from other databases or that address to similar types of data.

In addition, historical data on the berthing and non-berthing of ships must be obtained. For example, TRANSPERTO'S (Sistema de Informações de Movimentações e Estadias) (Movement and Stay Information System) (SIME) can be used, in which, among other data, historical records of berthing and non-berthing of ships are recorded, as well as their justification. Data on non-berthing due to bad weather can be used to train machine learning tools in regions where there is no indication of berthing, whereas data indicating berthing can be used as a positive situation, allowing ships to berth.

Notwithstanding, it will be appreciated that the present invention could take advantage of or aggregate historical data on berthing and non-berthing of ships from other databases or that address to similar types of data.

The variables mentioned are correlated with berthing and impossibility of berthing events in a structure; for example, this structure will be considered a monobuoy in a given region/location. The correlation allows the creation of a chronologically ordered database. The columns of the database are interpreted as a multivariable function, of the type

f(\vec{x})=y, [symbol] ⁹→[0,1]

where the variables mentioned are considered the input of the function. y=0 is considered for historical events of non-berthing and y=1 for events where there was the possibility of berthing a ship at the monobuoy.

In the implementation of a model, the \vec{x} vector, meteorological forecast, is called the independent variable, predictor variable or explanatory variable because it has a known value. y, implemented as the probability of berthing, is called the dependent variable, outcome variable or response variable because its value is unknown.

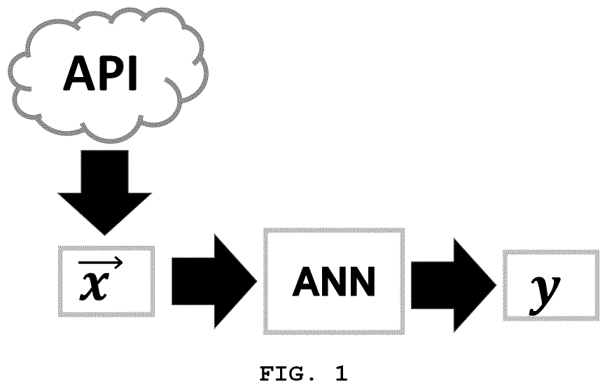

To model the problem in question, an Artificial Neural Network (ANN) was chosen to learn, consisting of a task of predicting the probability of a ship berthing at a monobuoy (or other structure) based on independent variables. The independent variables, meteorological forecast, are obtained through an application programming interface (API) and inserted into the ANN model, with the output of this model having a value of 0 and 1 that indicates the probability of any ship berthing at the monobuoy. FIG. 1 illustrates the data flowchart including the neural network model.

### ANN Structure

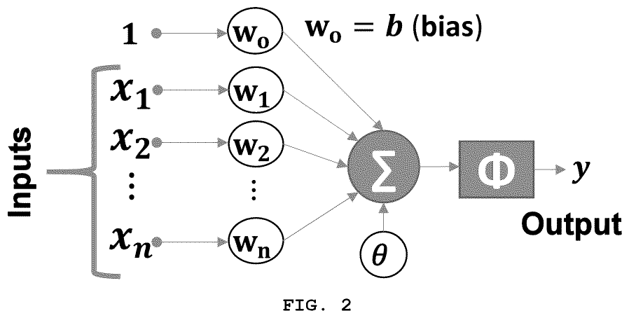

An ANN is composed of one or more artificial neurons, interconnected through synaptic connections, with the purpose of simulating the functioning of the human Nervous System (NS). A neuron in an ANN, illustrated in FIG. 2, is usually represented in a simplified way, with the following distinct parts:
Input Signals (x1, x2, . . . , xn): these are the inputs that represent information received by the neuron. These inputs can be numerical values coming from other layers of neurons or from external sensors.
Synaptic Weights (w1, w2, . . . , wn): each input is multiplied by a corresponding synaptic weight. The synaptic weights determine the importance of each input for the neuron and are adjusted during the training of the ANN.
Linear Aggregator (Σ): the inputs weighted by the synaptic weights are added together to produce a value, which is called the activation potential.
Activation Threshold (θ): the activation potential is compared to an activation threshold. If the activation potential exceeds the threshold, the neuron is activated; otherwise, it remains inactive.
Bias: The bias is a constant value added to the result of the weighted sum of the inputs and weights in a neuron of an ANN. It allows a neuron to make decisions even when all inputs are equal to zero. It is an adjustable parameter during ANN training to customize the neuron's behavior.
Activation Function (Φ): If the neuron is activated based on the comparison between the activation potential and the threshold, the activation function is applied to the activation potential to determine the neuron's output. The activation function can be of the sigmoid type, ReLU (Rectified Linear Unit), hyperbolic tangent or others, depending on the ANN architecture.
Output (y): The neuron's output is the final result after applying the activation function. This value can be passed to other layers of neurons or used as the final result of the ANN, depending on the network architecture.

Artificial neural network topologies refer to the structural organization and arrangement of the neurons in a network. The choice of topology plays a fundamental role in the performance and learning capacity of an ANN. Some of the most common topologies are: Feedforward, Multilayer Perceptron (MLP) Neural Networks, Convolutional Neural Networks (CNN), Recurrent Neural Networks (RNN), Deep Neural Networks (DNN) and Autoencoder Neural Networks.

In particular, for the present invention, the MLP topology was preferably adopted; these ANNs are often recommended for classification tasks where the desired output is a probability or a probability distribution over several classes. MLPs are suitable for multivariable functions, and are capable of learning complex relations in the data, which is essential in many classification problems.

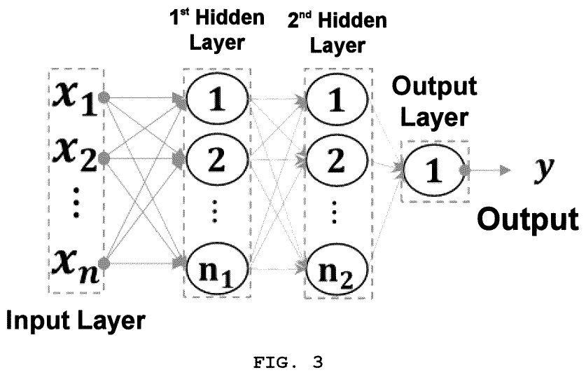

An MLP is composed of several layers of neurons, each with its specific function. The layers of an MLP, illustrated in FIG. 3, include:
Input Layer: This is the first layer of the network. Each neuron in the input layer represents an input variable. The number of neurons in this layer corresponds to the number of resources (variables) in your input data, i.e., nine neurons in our application.
Hidden Layers: Hidden layers, also called intermediate layers, are located between the input layer and the output layer. The number of intermediate layers and the number of neurons in each layer can vary depending on the network design. Each neuron in an intermediate layer is connected to all neurons in the previous layer and the next layer (if any). The intermediate layers are responsible for learning intermediate representations and characteristics of the data.
Output Layer: This is the last layer of the network. The number of neurons in the output layer depends on the type of problem being solved. For binary classification problems, with an output between 0 and 1, there is only one neuron in the output layer. In multiclass classification problems, there will be one neuron for each class. The output layer produces the final predictions of the network.

### Network Definition and Training

As already shown, an MLP-type network was adopted for the present invention. Notwithstanding, it will be appreciated by a technician skilled on the subject that different types of alternative neural networks, such as those already listed above, can be used for similar purposes with minimal adaptation to the methods described in this document.

As illustrated in FIG. 3, to define the topology of the neural network to be used, the number of hidden layers and how many neurons will be in each of these layers must be defined. To optimize the topology to be used, topologies of one to three hidden layers were trained, ranging from 1 to 10 neurons each. The activation functions used for each neuron were of the hyperbolic tangent type, or tanh, frequently used in neural networks to model nonlinear relations in classification tasks. In the output layer, the sigmoid function was used to produce probabilities in binary classification problems, since its results, in the range [0, 1], can be interpreted as the probability of a given instance belonging or not to a given class, that is, the possibility or not of berthing.

With the prediction history of at least one year, different MLP neural network topologies were trained, varying the number of internal layers and the neurons in each layer, as previously mentioned. The data was divided into nighttime (for example, between 5:00 p.m. and 5:00 a.m.) and daytime (the rest of the time that was not defined as nighttime). A different neural network was modeled for each set of data, nighttime and daytime, since the nighttime berthing scenario is generally more challenging and requires greater conservatism from the operator.

The input layer refers to the nine known variables, while the output layer, by definition, has only one neuron, since the model is the scalar function: f(\vec{x})=y, [symbol] ⁹→[0,1].

In addition to the nine variables mentioned, a visibility criterion can be included. Different values of the visibility criterion can be adopted, depending on each application case. For example, for nighttime berths, a minimum visibility of 1 nautical mile (1852 m) can be adopted, while in the daytime model, a minimum visibility of 0.5 nautical miles (926 m) can be adopted. If the visibility forecast is lower than the minimum value required predefined for each case, the output is forced to zero.

For each network analyzed, the parameters of each neuron (synaptic weights, activation threshold and bias), defined in FIG. 2, are defined in the network training process, which can be done using advanced statistical software, such as the JMP software. However, in test environments, networks were also trained using the Tensorflow and Keras libraries, both for development in the Python language.

For network training, in addition to dividing the data into nighttime and daytime data, for each time interval (time interval for which a prediction is estimated), the historical data can be divided into training data (such as, for example, 80%), used to train the model, and validation data (for example, the remaining 20%), used to compare different models and hyperparameters.

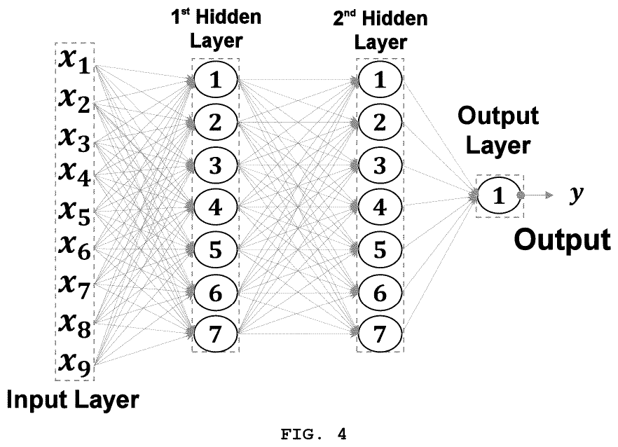

The topology that presented the greatest accuracy in the validation data, both for nighttime and daytime berthing, was a topology with two hidden layers with seven neurons each, using the hyperbolic tangent function as the activation function. The topology is completed by the input layer with nine variables and the output layer, with one neuron using the sigmoid activation function, as illustrated in FIG. 4.

### Model Implementation

The entire implementation of the model was done in Python, including the neural network trained in the JMP software, since the aforementioned software allows the extraction of functions for implementation in Python.

Therefore, the code related to the network topology illustrated in FIG. 4 was extracted, containing all the parameters necessary for modeling the network and implemented in the general code.

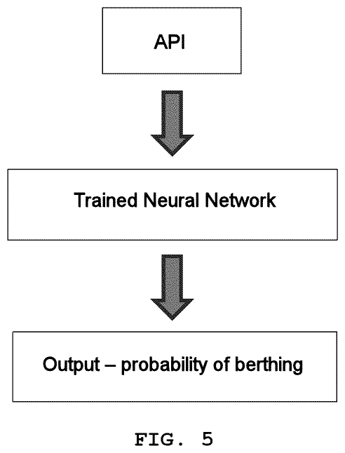

FIG. 5 shows an example of the implementation of the model, which can be in Python, where, through an API, the forecast data (input variables) are acquired in a window of days (for example, 10 days); this data is converted into chronologically organized tables and inserted into the trained code.

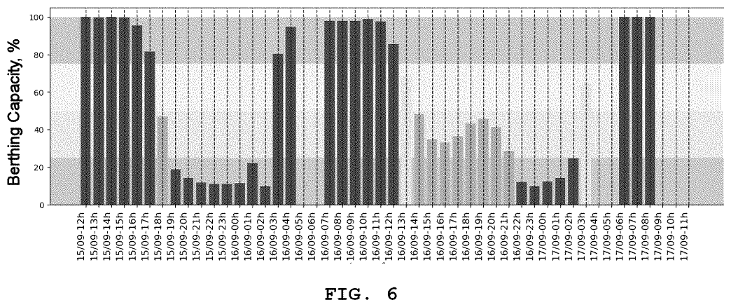

The output of the model is the percentages of probability of the ship berthing. The output of the model can be configured to be every hour, day or for an interval (for example, a given interval of hours). FIG. 6 illustrates, by way of example, the output of the model in graphical format, indicating the probability of berthing resulting from the model in question for an exemplary window of 48 hours. The output of the model, i.e. the probability of the ship berthing, can also be automatically sent via an e-mail, a notification in an app, a notification integrated into a control system or other means of warning/notification.

### PREFERRED EMBODIMENTS OF THE INVENTION

A method for training an artificial neural network model, ANN, to predict the berthing capacity of ships, according to a preferred embodiment of the present invention, comprises at least:
a) obtaining historical data on meteorological forecasts containing information regarding a plurality of meteorological variables of a target region;
b) obtaining historical data on the berthing and non-berthing of ships of the target region;
c) correlating the historical data on the berthing and non-berthing of ships with the data of the plurality of meteorological variables to create an ordered database; and
d) feeding the ANN model with the ordered database created for training and defining the parameters of the ANN model.

The training method may further comprise dividing the data obtained into nighttime and daytime data and, for each data set, a different neural network is modeled, since the nighttime berthing scenario is, in general, more challenging and requires greater conservatism from the operator.

The meteorological variables of the target region may be wind direction, sea current direction, significant wave height, maximum sea wave height, peak of the sea wave period, wind speed, wind gusts, temperature and precipitation.

The model training method may further comprise a visibility criterion, for nighttime and daytime berthing, respectively. If the visibility forecast is less than a minimum value required predefined for each case, the model output is forced to zero.

For each time interval, the historical data may be divided into training data, used to train the model, and validation data, used to compare different models and hyperparameters.

Furthermore, a method for predicting the berthing capacity of ships is provided, according to another preferred embodiment of the present invention, which comprises, at least:
a) acquiring forecast data of current meteorological variables (x) relating to a target region for berthing of a ship for a predefined time interval;
b) feeding an artificial neural network, ANN, model trained with said forecast data of current meteorological variables (x); and
c) obtaining a continuous prediction of the probability of berthing viability (y) of a ship for the predefined time interval.

The method further comprises notifying the probability of berthing viability (y) of the ship for the predefined time interval.

It will be appreciated by one skilled in the art that embodiments of the present invention may be implemented by computer. Accordingly, aspects of the present invention may take the form of one or more computer-readable media comprising a set of computer-readable instructions embedded/stored therein for execution by a processor. A computer-readable medium may be a computer-readable storage medium. A computer-readable storage medium may be any tangible medium that may contain or store a set of instructions for execution of embodiments of the present invention.

In general, a computer-readable storage medium may be, for example: an electronic, magnetic, optical, electromagnetic, infrared, semiconductor system, apparatus or device, or any combination thereof.

More specifically, although not exhaustively, a computer-readable storage medium may be, for example: a hard disk, a random access memory (RAM), a read-only memory (ROM), an erasable programmable read-only memory (EPROM/Flash memory), an optical fiber, a portable compact disc read-only memory (CD-ROM), an optical storage device, a magnetic storage device or any combination thereof.

Those skilled in the art will value the knowledge presented herein and will be able to reproduce the invention in the presented embodiments and in other variants, encompassed by the scope of the attached claims.

1. A method for training an artificial neural network, ANN, model to predict the berthing capacity of ships, characterized in that it comprises the steps of:
a) obtaining historical data on meteorological forecasts containing information regarding a plurality of meteorological variables of a target region;
b) obtaining historical data on the berthing and non-berthing of ships of the target region;
c) correlating the historical data on the berthing and non-berthing of ships with the data of the plurality of meteorological variables to create an ordered database; and
d) feeding the ANN model with the ordered database created for training and defining the parameters of the ANN model.

2. The method according to claim 1, further comprising a division of the data obtained into nighttime and daytime data and, for each data set, a different neural network is modeled.

3. The method according to claim 1, wherein the meteorological variables of the target region may be variables of wind direction, sea current direction, significant wave height, maximum sea wave height, peak of the sea wave period, wind speed, wind gusts, temperature and precipitation.

4. The method according to claim 1, further comprising a visibility criterion for nighttime and daytime berths, respectively.

5. The method according to claim 1, wherein for each time interval, the historical data may be divided into training data, used to train the model, and validation data, used to compare different models and hyperparameters.

6. A method for predicting the berthing capacity of ships, comprising the steps of:
a) acquiring forecast data of current meteorological variables (x) relating to a target region for berthing of a ship for a predefined time interval;
b) feeding an artificial neural network, ANN, model trained with said forecast data of current meteorological variables (x); and
c) obtaining a continuous prediction of the probability of berthing viability (y) of a ship for the predefined time interval.

7. The method according to claim 6, further comprising notifying the probability of berthing viability (y) of the ship for the predefined time interval.

8. The method according to claim 6, wherein the meteorological variables of the target region can be variables of wind direction, sea current direction, significant wave height, maximum sea wave height, peak of the sea wave period, wind speed, wind gusts, temperature and precipitation.

9. The method according to claim 6, characterized in that it further comprising comprises a visibility criterion, for nighttime and daytime berths, respectively.

10. A non-transitory computer-readable medium, characterized in that it stores a set of instructions that, when executed by a processor, cause the processor to perform the method as defined in claim 1.

11. A non-transitory computer-readable medium, characterized in that it stores a set of instructions that, when executed by a processor, cause the processor to perform the method as defined in claim 6.
